(19) United States
(12) Patent Application Publication
(10) Pub. No.: US 2011/0264019 A1
(43) Pub. Date: Oct. 27, 2011

(54) ABDOMINAL TRAINING DEVICE

(76) Inventor: Geon Uk Park, Incheon (KR)

(21) Appl. No.: 13/120,918

(22) PCT Filed: Sep. 15, 2009
(86) PCT No.: PCT/KR2009/005224

§ 371 Date: Mar. 24, 2011

(30) Foreign Application Priority Data
Sep. 24, 2008 (KR) 10-2008-0093615

(51) Int. Cl. A61H 23/00

(52) U.S. Cl. 601/108

(57) ABSTRACT

The present invention is intended to train and strengthen the muscles of a certain area of the body and relates to specifically to an abdominal exercise devoice that strengthens the muscles of the abdomen or removes subcutaneous fat so that an ideal abdominal state may be achieved. Provided is an abdominal impact device that may be used in a sitting or standing position, comprising a cylinder operated by oil pressure or air pressure, a piston that is moved by the cylinder in a reciprocating way, an impact ball that is furnished at the tip of the piston for impact, and a control panel that controls said cylinder so as to provide an abdominal exercise device that enables abdominal strengthening and the breakdown of subcutaneous fat by impact.

### TECHNICAL FIELD

The present invention relates to an abdominal training device to train the muscles of a certain portion of a body, and in particular to an abdominal training device which helps make an ideal body style by strengthening abdominal muscles and by removing subcutaneous fat.

### BACKGROUND ART

Beautiful abdominal muscles are generally made by a continuous abdomen strengthening exercise while strengthening abdomen.

There are a lot of problems for modern people to train and strengthen the abdomen with the aid of a continuous exercise, and in case of middle-aged persons, most of them are suffering from various diseases due to abdomen fat.

Various types of exercise devices are manufactured, which are capable of train or strengthen abdomen for a short time period. Many persons train and strengthen their abdominal muscles by using such abdominal exercise devices.

The Korean patent publication number 10-2006-109603 discloses an abdominal exercise device, which device comprises rotatable seats, and inclined supports, so a user does exercises with his abdomen and back being supported on the seat while smoothly moving abdomen and back. The Korean utility model number 20-393199 discloses a sitting type abdominal training device which is characterized in that an eccentric cam is installed at a lower side of a seat, so the device can tilt in left and right directions. A user can naturally do an abdominal exercise while the user sitting on the seat is trying to keep a balance.

In addition, as a portable abdominal exercise device, there is provided a portable abdomen vibrator which is designed to generate vibrations with the aid of the rotations of an oval cam driven by means of a motor installed in the interior of a belt shaped casing in order to transfer vibrations to a surface contacting with an abdomen for thereby exercising abdomen. The Korean utility model registration number 20-437338 discloses an abdomen exercise device characterized in that an acupressure roll is engaged at an inner wall part of a body made of an elastic material in a C-ring shape, and the abdomen wears the ring shape body, and the abdomen is acupressure-treated and massaged by rotating the handles of outer sides in left and right directions.

Among the above conventional abdomen exercise devices, the sitting type abdomen exercise device is directed to exercising abdomen by driving the seat with a user sitting on the sear. In this case, a heavy user cannot use the device. Since the waist and back are concurrently stimulated, an old user might be hurt in the course of exercise, which might lead to an undesired side effect.

In addition, since the portable abdomen exercise device is basically designed to stimulate abdomen with the aid of vibrations or stimulate abdomen in a massage method, exercise effects are very low, and exercise efficiency is very low as well.

### DISCLOSURE OF INVENTION

Accordingly, it is an object of the present invention to provide an abdominal training device which overcomes the problems encountered in a conventional abdomen exercise device and trains the abdomen with the aid of physical impact externally applied not depending on simple vibrations and distortions, strengthens abdominal powers while training skins and muscles for thereby forming good-looking muscles, while efficiently burning subcutaneous fat.

To achieve the above object, there is provided an abdomen training device which comprises an abdominal training device which is designed so that a user uses sitting or standing and which comprises a cylinder which operates by an oil pressure or an air pressure, a piston which reciprocates by means of the cylinder, an impact part for impacting an end of the piston, and a control panel for controlling the cylinder for thereby strengthening abdomen by impacts and burning subcutaneous fat.

### BRIEF DESCRIPTION OF THE DRAWINGS

The present invention will become better understood with reference to the accompanying drawings which are given only by way of illustration and thus are not limitative of the present invention, wherein;

FIG. 1 is a front view illustrating an abdominal training device according to an embodiment of the present invention;

FIG. 2 is a side view illustrating an abdominal training device according to an embodiment of the present invention;

FIG. 3 is a plane view illustrating an abdominal training device according to an embodiment of the present invention;

FIG. 4 is a perspective view illustrating an impact part according to the present invention;

FIG. 5 is a view of another example of an impact part according to the present invention;

FIGS. 6A and 6B are views of further another example of an impact part according to the present invention;

FIG. 7 is a view of another example of an impact part according to the present invention;

FIGS. 8 and 9 are exemplary views illustrating an operation part of an impact pat according to the present invention; and

FIG. 10 is a side view illustrating a state that an acupressure part is engaged to an abdomen training unit according to the present invention.

### MODES FOR CARRYING OUT THE INVENTION

The abdominal training device according to the present invention comprises a driving force generation means for generating an impact driving force by receiving power; an abdomen impact means for impacting a user's abdomen by receiving a driving force from the driving force generation means and converting the driving force into a horizontal movement; a height adjusting means for adjusting the height of an abdomen impact means depending on a user's body status; and a control means for controlling the driving force generation means and the abdomen impact means, respectively.

The driving force generating part may be formed of an air compressor or an oil pressure unit.

The abdomen impact part comprises a cylinder operating by air pressure or oil pressure, a piston rod engaged to the cylinder, and a spherical impact part engaged to an end of the piston rod. The abdomen impact part might be formed like an eccentric cam or a crank is connected to a mechanically formed driving motor and might rotate for thereby impacting abdomen.

The control part can set a basic pressure so as to control the pressure of an air compressor or a hydraulic generator to set at a proper level on the surface of the control panel and can set or input a certain value for the operation cycle and an impact strength and impact level of a cylinder by means of an abdomen impact part to be used in a combined form or a singular form.

The present invention formed of such part might be movable and comprises a frame fixed at a base substrate, a table engaged at the frame and movable up and down, an air compressor for supplying compressed air, a cylinder operating by means of compressed air from the air compressor, and elastic impact part engaged at an end of the piston in the cylinder, with the cylinder being engaged at the table, with the control panel being engaged at the table for thereby controlling the operations of the cylinder and the air compressor.

A caster is engaged at the base substrate of the lower side of the frame for facilitating the movement to be easier. The table engaged at the frame has a frame holder for moving up and down along the frame and might be fixed at an outer side of the frame holder by a locking part. A support part might be formed at either an upper side or an intermediate portion of the table or the frame for reading.

In the above construction of the present invention, the user takes a position closer to the table and adjusts the operation cycle, pressure and impact speed of the piston by operating the control panel and starts operating, so the pressure from the air compressor is supplied to the compression cylinder and reciprocates the piston rod.

A solid impact part is engaged at an end portion of the reciprocating piston for thereby preventing the skin from being hurt when impacting a user's abdomen.

As the impact part of the reciprocating keeps impacting, the muscles of the abdomen are strengthened while burning and removing subcutaneous fat.

The abdominal training device according to the present invention will be described in more details with reference to the accompanying drawings.

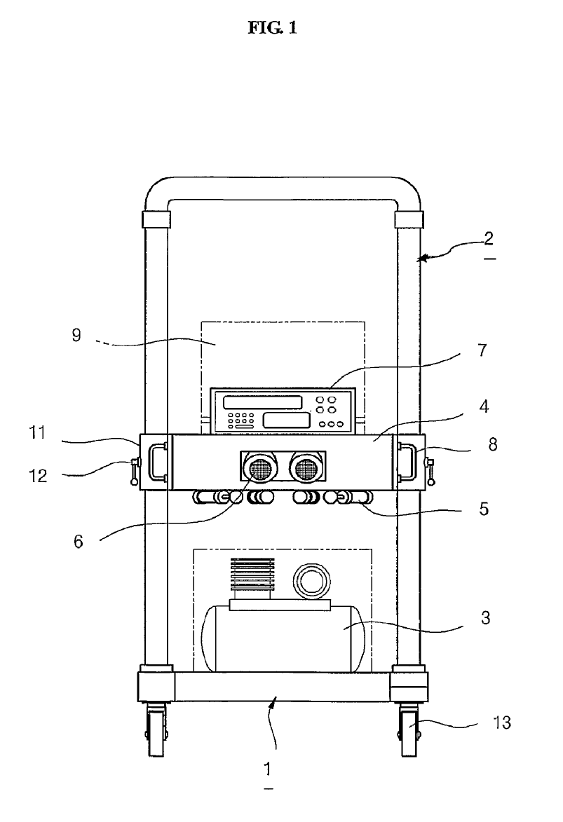

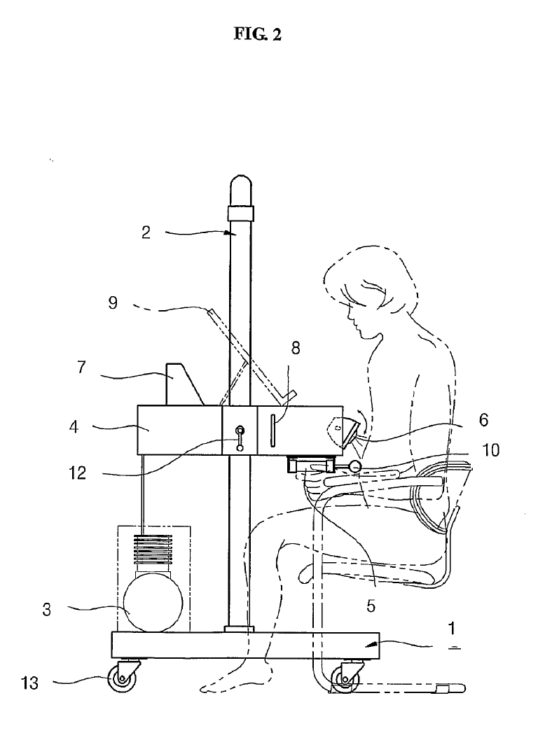

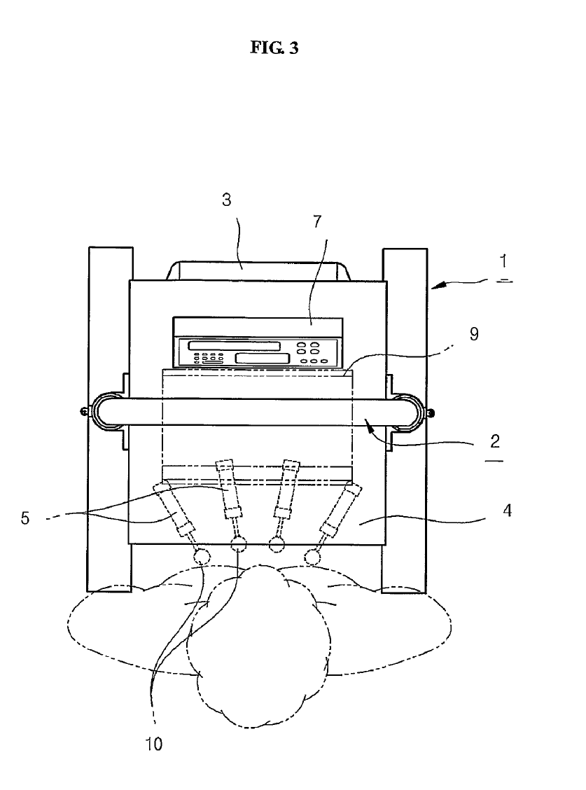

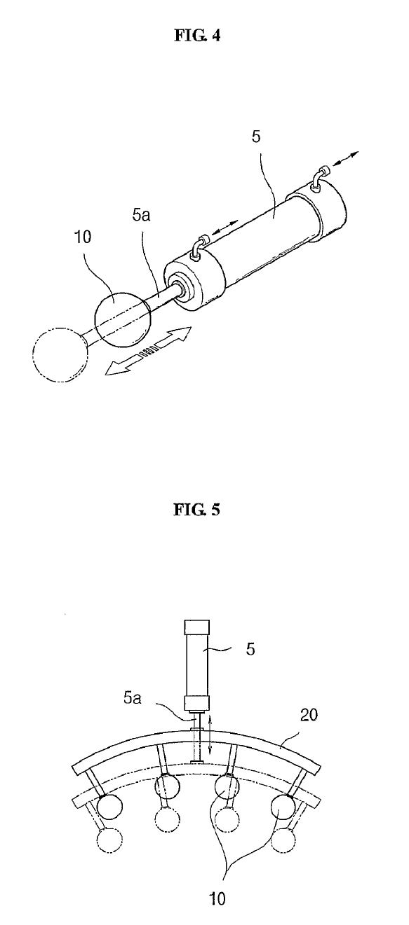

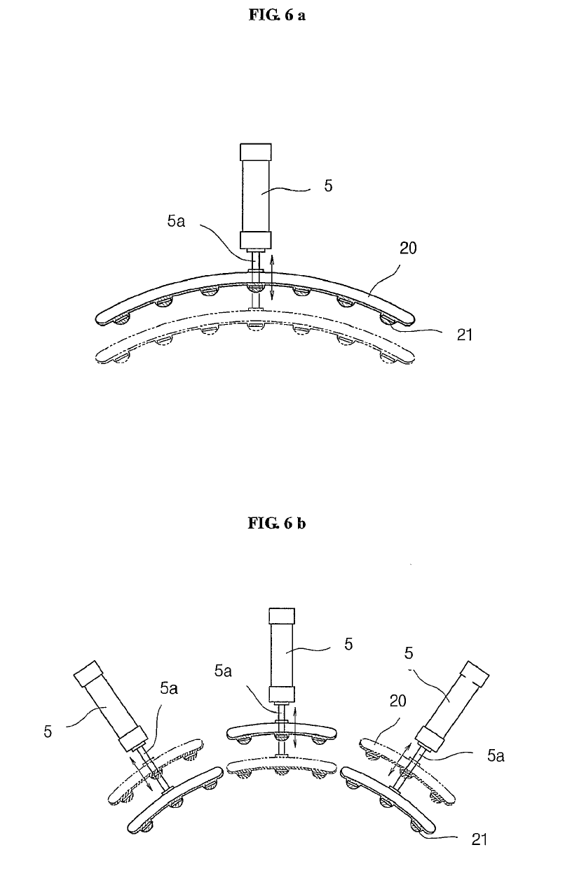

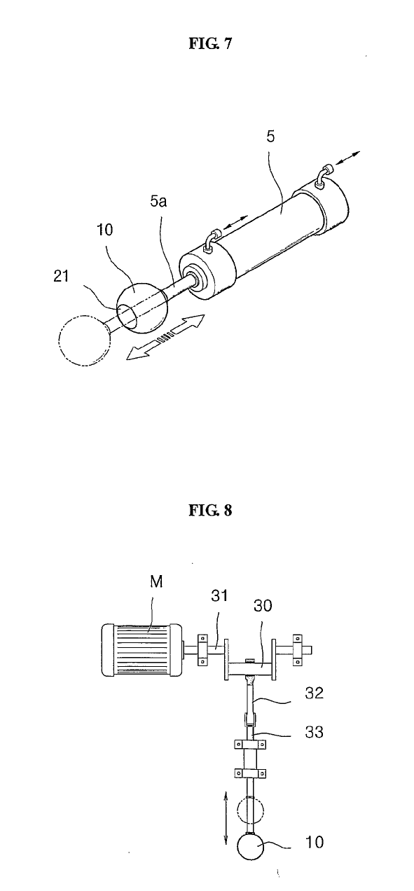

FIG. 1 is a front view of an abdominal training device according to an embodiment of the present invention, FIG. 2 is a side view of a use state according to the present invention, FIG. 3 is a plane view of a use state of the present invention, FIG. 4 is a perspective view of the construction of an impact part of the present invention, and FIGS. 5 and 6 are plane views of another example of an impact part of the present invention.

An upside down U-shaped frame 2 is fixed at the upper surface of the base substrate 1, and an air compressor 3 is engaged at a center rear side, and the table 4 is installed between the frames 2, and the frame 2 is installed at both sides and is movable by the slide cover 11, and one to five cylinder 5 connected with the air compressor 3 are arranged in a radial shape at the bottoms side of the table 4. A spherical impact part 10 is provided at an end portion of the piston rod 5a of the cylinder 5. A control panel 7 is installed at the upper side of the table 4 for controlling the operations of the air compressor 3 and the cylinder 5.

A handle 8 is engaged at both sides of the table 4, and a book rest 9 is engaged at an upper surface for an easier reading posture of a user.

A locking handle 12 is thread-engaged to the slide cover 11 which fixes the table 4 at the frame 2, so the table 4 can be fixed at the frame 2 with adjusted height.

An infrared ray lamp 6 whose radiation angle can be adjustable is installed at the front side of the table 4 for thereby concurrently performing the functions that the user's abdomen can be trained, and the sanitization by the infrared ray lamp 6 is possible, and the warming effect is obtained.

The impact part 10 might be performed by means of either the crank 30 or the eccentric cam 34. The caster 13 is engaged at a bottom side of the base substrate 1 for an easier movement.

An acupressure part 50 for acupressure-treating sole is provided at the base substrate 1. The acupressure part 40 might move up or down with the aid of the eccentric cam 40 or the crank 43 or might move up or down by using the cylinder S.

The control panel 7 has a pressure adjusting function of the air compressor 3 of the abdomen training device and has the functions of setting the operation cycle, the operation time and the striking power of the cylinder 5, while controlling the operation time of the infrared ray lamp 6.

The operation of the present invention will be described.

The operation will be described assuming that a user uses the device of the present invention while sitting on a seat of the abdomen training device.

The seat is moved to the front side of the base substrate 1. After the user sits, the position of the table 4 fixed at the frame 2 is adjusted depending on the physical status of the user. The fixed state is unlocked by rotating the locking handle 12 of the slide cover 11 fixed at both sides of the table 4, and the height is adjusted by moving up or down, and it is fixed again by rotating the locking handle 12.

The height of the table 4 is positioned so that the impact part 10 engaged at the piston rod 5a of the cylinder 5 engaged at the lower side of the table 4 is positioned at the height of the abdomen of the user, and the interval between the impact part 10 and the abdomen is adjusted and fixed.

The operation time and pressure of the cylinder 5 is set by using an input part of the control panel 7, and the device gets started.

The pressure of the air compressor 3 is transferred to the cylinder 5 based on the value set by a start signal of the control panel 7, and the piston rod 5a moves forward, and the impact part 10 impacts the user's abdomen.

The operation levels of the cylinder 5 is controlled based on the inputted values of the control panel 7, and the impact part 10 fixed at an end of the piston rod 5a repeatedly hits the abdomen of the user for thereby training and strengthening the abdomen.

One cylinder 5 engaged at the bottom of the table 5 is provided. In this case, each cylinder 5 is arranged along the curved portions of the abdomen. Since the impact part 10 engaged at the piston rod 5a of the cylinder 5 arranged along the curved portions of the abdomen repeatedly impacts the abdomen, subcutaneous fat can be effectively burnt.

In the present invention, as shown in FIG. 5, the cylinder 5 engaged at the bottom of the table 4 is configured like the curved installation plate 20 is fixed at one cylinder 5 and the piston rod 5a, and a plurality of the impact parts 10 are engaged at the installation plate 20.

When a plurality of the impact parts 10 are engaged at one installation plate 20, is possible to decrease the unit cost of manufacture, and power consumption can be decreased by saving the compressed air of the air compressor 3.

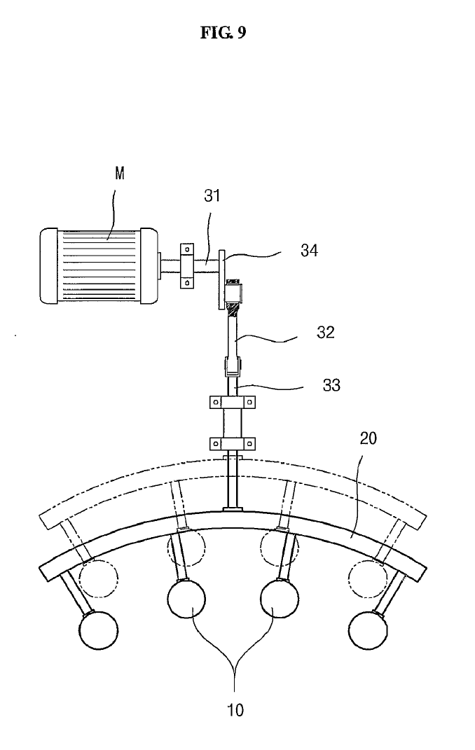

As shown in FIG. 6, the permanent magnet 21 is fixed at the front side of the installation plate 20 for thereby efficiently impacting the abdomen of the user. The magnetic force from the magnets is transferred to the abdomen in the course of impacts. As shown in FIG. 7, the permanent magnets 21 might be embedded at the front side of the impact part 10.

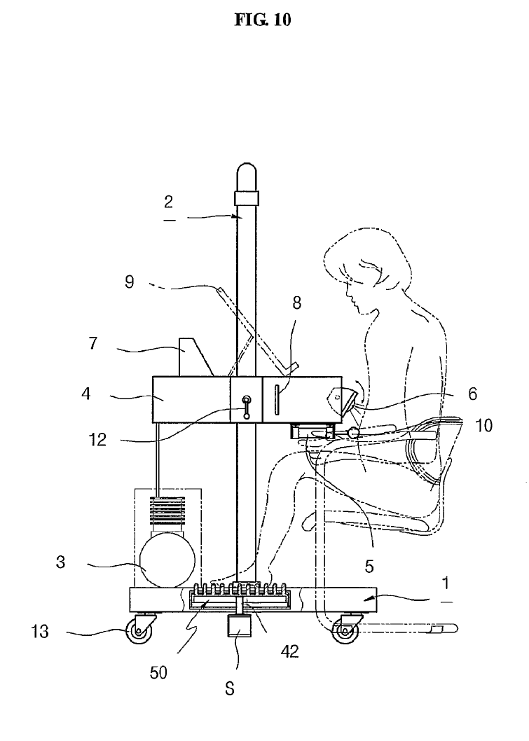

As shown in FIG. 8, the impact part 10 is configured to repeatedly hit the abdomen of the user in such a manner that the crank 30 is connected to the rotary shaft 31 of the driving motor M, and the connection rod 32 and the operation rod 33 are closely contacted with the crank 30, and the impact part 10 is engaged at an end portion of the operation rod 33 in a mechanical construction. As the operation rod 33 horizontally reciprocates with the aid of the rotation of the driving motor M, the abdomen of the user is repeatedly impacted.

The connection rod 32 is configured like the eccentric cam 34 is engaged at the rotary shaft 31 of the driving motor M, and the connection rod 32 and the operation rod 33 closely contact with the eccentric cam 34 and horizontally operate, which are shown in FIG. 9.

The control panel 7 is configured like as the operation of the cylinder 5 starts in accordance with an operation signal of the user, the infrared ray lamp 6 installed at a front side of the table 4 is turned on, and infrared ray is emitted to the abdomen of the user. The infrared ray provides sanitization effects along with heat for thereby further burning the fat of abdomen. The low frequency pad (not shown) is engaged at the surface of the impact part 10. The low frequency generation pad is separately equipped with a low frequency generation device for supplying low frequency and a pad electrically connected with the low frequency generation device. So, the low frequency generation device is engaged at the table 4, and the low frequency generation pad is attached to a front side of the impact part 10.

At the moment when the impact part 10 impacts the abdomen, the low frequency from the low frequency generation pad stimulates the acupuncture stops of the abdomen for thereby facilitating the circulation of the blood and relaxing the muscles. In addition, the handle 8 is installed at both sides of the table 4, and when the abdomen is impacted with the user holding the handle 8, the user gives more strength to the abdomen, so it is possible to prevent the body from moving backward.

The book stand 9 is engaged at the upper side of the table 4, so the user can have a fun of reading books in the course of training without feeling boring.

The table 4 engaged at the frame 2 fixed at the base substrate 1 can adjust its height. When the user wants to do exercise standing based on a user's intent, the height of the table 4 is moved up or down and is fixed at a certain height and then is used.

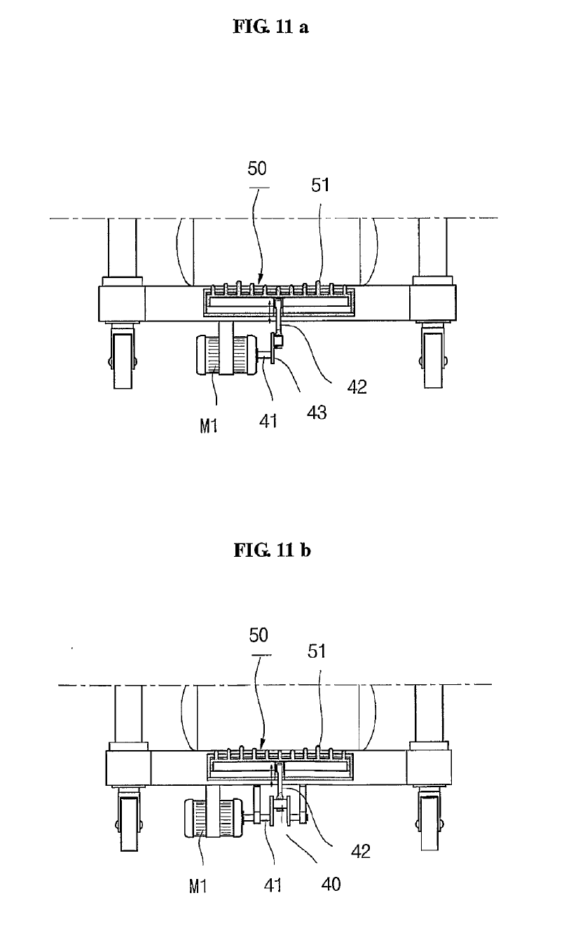

In the present invention, the acupressure part 50 is provided at the upper side of the base substrate 1. The height of the acupressure pat 50 is adjusted so that a plurality of the acupressure parts 51 formed on the surface of the base substrate 1 are matched with the positions of the acupuncture spots formed on the sole of the user. When a user trains the abdomen while being sit on the seat, the sole can be concurrently acupressure-treated, which helps relax fatigue. The acupressure protrusion 51 of the acupressure part 50 might be equipped with a move up and down part for facilitating an up and down movement. As shown in FIG. 10, the cylinder S is engaged at a lower side of the substrate from which the acupressure protrusion 51 is protruded for thereby moving up and down with the aid of oil pressure or air pressure from the air compressor 3. As shown in FIG. 11a, the up and down movement shaft 42 is engaged at a lower side of the acupressure part 50 in which the acupressure protrusions 51 are formed, and the crank 40 rotating by the driving motor M is engaged at the base substrate 1, and the up and down movement shaft 42 is connected to the crank 40 for thereby obtaining an up and down movement. As shown in FIG. 11B, the acupressure part 50 having the acupressure protrusions 51 is connected with the eccentric cam 43 connected with the driving motor M for thereby obtaining an up and down movement of the up and down movement part 42.

In the descriptions of the present invention, the construction of the movable table type has been described, but it can be fixed in a fixed type, and the device of the present invention can be installed at a common desk for thereby concurrently performing both a book reading and abdomen training, which might be easily modified by a person who skilled in the art and is obviously within the scope of the present invention.

### ADVANTAGEOUS EFFECTS

The abdominal training device according to the present invention is basically designed so that an impact part repeatedly hits the abdomen of a user in such a manner that a piston reciprocates forwards and backwards by means of an external pressure supplied to the cylinder while obtaining an abdomen skin training effect, an abdomen muscle strengthening effect, and a subcutaneous fat burning effect.

1. An abdominal training device, comprising:
a driving force generation means for generating an impact driving force by receiving power;
an abdomen impact means for impacting a user's abdomen by receiving a driving force from the driving force generation means and converting the driving force into a horizontal movement;
a height adjusting means for adjusting the height of an abdomen impact means depending on a user's body status; and
to a control means for controlling the driving force generation means and the abdomen impact means, respectively.

2. An abdominal training device according to claim 1, wherein said driving force generation means is either an air compressor or an oil pressure generator.

3. An abdominal training device according to claim 1, wherein said driving force generation means is directed to reciprocating and impacting with the aid of a mechanical operation of a crank or an eccentric cam which rotates by means of a driving motor.

4. An abdominal training device according to claim 1, wherein said abdominal impact means comprises:
a cylinder operating by means of either an air pressure or an oil pressure;
a piston rod which is engaged to the cylinder; and
a spherical impact part which is engaged to an end portion of the piston rod.

5. An abdominal training device according to claim 1, wherein said control means inputs a certain value or sets so that an operation cycle, an impact level, an operation time and an impact strength of the cylinder driving the abdomen impact means, can be set in a combined form or in a singular form.

6. An abdominal training device according to claim 1, wherein a sole acupressure part is provided at a lower side of the abdominal training device for stimulating acupuncture spots by acupressure-treating sole.

7. An abdominal training device, comprising:
an upside down U-shaped frame fixedly engaged at an upper surface of a base substrate;
an air compressor which is engaged at a center rear portion;
a table engaged between the frames;
a cylinder which is movable up and down along a frame with the aid of a slide cover at both sides, with the cylinder being connected with an air compressor at the bottom of the table;
a spherical impact part which is fixed at an end portion of the piston rod of the cylinder; and
a control panel which is provided at an upper surface of the table for controlling the operations of the air compressor and the cylinder.

8. An abdominal training device according to claim 7, wherein a curved installation plate is installed at a piston rod of the cylinder, with an impact part being installed at its front side.

9. An abdominal training device according to claim 7, wherein a permanent magnet is installed at a front side of the impact part.

10. An abdominal training device according to claim 7, wherein a low frequency generation pad is installed at a front side of the impact part.

11. An abdominal training device according to claim 7, wherein two to six cylinders engaged at the bottom of the table are arranged in a radial shape and are designed to operate in a sequence.

12. An abdominal training device according to claim 7, wherein a plurality of acupressure protrusions are protruded from an upper surface of the base substrate, which forms an acupressure part.

13. An abdominal training device according to claim 12, wherein said acupressure protrusions forming the acupressure part move up and down by means of a crank shaft connected with the driving motor.

14. An abdominal training device according to claim 12, wherein said acupressure protrusions forming the acupressure part moves up and down by means of an eccentric cam connected with the driving motor.

15. An abdominal training device according to claim 12, wherein said acupressure protrusions move up and down by means of a cylinder.

16. An abdominal training device according to claim 7, wherein a driving motor is engaged at the bottom of the table, and the eccentric cam is fixed at the rotary shaft, and the connection rod and the operation rod are closely contacted with the eccentric cam for a horizontal operation, with the impact part being engaged at an end portion of the rod.

17. An abdominal training device according to claim 16, wherein a crank is connected to the driving motor which is engaged at the bottom of the table, and the operation rod having the connection rod and the impact part is connected to the crank for thereby obtaining a horizontal direction movement.
